(19) United States
(12) Patent Application Publication
(10) Pub. No.: US 2015/0201763 A1
(43) Pub. Date: Jul. 23, 2015

(54) BACKLIGHT ASSEMBLY, DISPLAY APPARATUS HAVING THE SAME AND METHOD OF FABRICATING THE SAME

(71) Applicant: Samsung Display Co., Ltd., Yongin City (KR)

(72) Inventors: Kwang-Wook CHOI, Osan-si (KR); Sang-Heon YE, Cheonan-si (KR); Jae-Sang LEE, Asan-si (KR); Sang-Ho HWANG, Suwon-si (KR)

(21) Appl. No.: 14/315,182

(22) Filed: Jun. 25, 2014

(30) Foreign Application Priority Data
Jan. 22, 2014 (KR) 10-2014-0007810

(51) Int. Cl. A47G 1/06; B23P 19/02; G09F 13/04

(52) U.S. Cl. CPC A47G 1/0622; G09F 13/0413; B23P 19/02; A47G 2001/0666

(57) ABSTRACT

A backlight assembly includes a light source member, an optical film assembly, a rear receiving container and a mold frame. The rear receiving container includes a bottom plate and a plurality of sidewalls. Each of the sidewalls includes a first combining protrusion and a first combining recess. The first combining protrusion and the first combining recess extend in a direction substantially parallel with the protruded direction of the sidewall. The mold frame is disposed in the rear receiving container to press a peripheral portion of the optical film assembly. The mold frame includes a second combining recess and a second combining protrusion. The second combining recess and the second combining protrusion extend in the direction substantially parallel with the protruded direction. The second combining recess is fitted with the first combining protrusion. The second combining protrusion is fitted with the first combining recess.

### PRIORITY STATEMENT

The application claims priority under 35 U.S.C. § 119 to Korean Patent Application No. 10-2014-0007810, filed on Jan. 22, 2014 in the Korean Intellectual Property Office (KIPO), the contents of which application are herein incorporated by reference in their entirety.

### BACKGROUND

1. Field of Disclosure

The present disclosure of the inventive concept relates to a backlight assembly, a display apparatus having the same and a method of fabricating the same. More particularly, the present disclosure of the inventive concept relates to a backlight assembly capable of being easily assembled and fabricated, a display apparatus having the same to decrease defects and a method of easily fabricating the same.

2. Description of Related Technology

Display apparatuses include an active-typed display apparatus and a passive-typed display apparatus. The active-typed display apparatus displays an image using an active element generating light. The passive-typed display apparatus displays an image by controlling transmittance of light generated from a light source.

The passive-typed display apparatus includes a display panel and a backlight assembly. The display panel includes a liquid crystal element, an electrophoretic element, etc. The backlight assembly provides light to the display panel.

The backlight assembly includes a plurality of elements having a light source, a light guide plate, an optical sheet. etc. The light source generates light. The light guide plate guides the light to an upper side of the backlight assembly. The optical sheet is disposed on the light guide plate to improve optical characteristics of the light existing from the light guide plate.

However, when the number of the elements is increased, the fabrication process becomes complex. Also, when the elements such as the optical sheets are not securely fixed, the elements may be dislocated from a right position by an externally provided impact.

In addition, when the backlight assembly is integrally formed with the display panel, the fabrication process for a plurality of receiving containers becomes more complex and errors in the fabrication process increase.

### SUMMARY

A backlight assembly capable of being easily assembled and fabricated is provided.

A display apparatus having the above-mentioned backlight assembly is also provided.

A method of easily fabricating the above-mentioned backlight assembly is also provided.

According to an exemplary embodiment, a backlight assembly includes a light source member an optical film assembly, a rear receiving container and a mold frame. The light source member is configured to generate light. The optical film assembly is disposed on the light source member and is configured to improve optical characteristics of the light. The rear receiving container receives the light source member and the optical film assembly. The rear receiving container includes a bottom plate and a plurality of sidewalls. The sidewalls protrude from sides of the bottom plate. Each of the sidewalls includes a first combining protrusion and a first combining recess. The first combining protrusion and the first combining recess extend in a direction substantially parallel with the protruded direction of the sidewall. The mold frame is disposed in the rear receiving container to press a peripheral portion of the optical film assembly. The mold frame includes a second combining recess and a second combining protrusion. The second combining recess and the second combining protrusion extend in the direction substantially parallel with the protruded direction. The second combining recess is fitted with the first combining protrusion. The second combining protrusion is fitted with the first combining recess.

In an embodiment, the first and second combining protrusions may have a substantially wedge shape.

In an embodiment, the first combining protrusion and the second combining protrusion may have at least one selected from the group consisting of a rounded hammer shape and a substantially rectangular shape.

In an embodiment, the first combining protrusion and the first combining recess may be on an inner surface of the sidewall, and the second combining protrusion and the second combining recess may be on an outer surface of the mold frame.

In an embodiment, the first combining protrusion, the first combining recess, the second combining protrusion and the second combining recess may have substantially the same height as the mold frame.

In an embodiment, the first combining protrusion, the first combining recess, the second combining protrusion and the second combining recess may have a smaller height than the mold frame.

In an embodiment, the first combining protrusion and the first combining recess may be on an upper portion of the rear receiving container, and the second combining protrusion and the second combining recess may be on an upper portion of the mold frame.

In an embodiment, a rear receiving groove may be on a rear surface of the mold frame, and the sidewall of the rear receiving container may be received in the rear receiving groove.

In an embodiment, the first combining protrusion and the first combining recess may be on an outer surface of the sidewall, the second combining protrusion and the second combining recess may be on an inner surface of the rear receiving groove, which faces an outer surface of the sidewall.

In an embodiment, the first combining protrusion, the first combining recess, the second combining protrusion and the second combining recess may have substantially the same height as the sidewall of the rear receiving container.

According to an exemplary embodiment, a display apparatus includes a backlight assembly and a display panel. The backlight assembly includes a light source member, an optical film assembly, a rear receiving container and a mold frame. The light source member is configured to generate light. The optical film assembly is disposed on the light source member and is configured to improve optical characteristics of the light. The rear receiving container receives the light source member and the optical film assembly. The rear receiving container includes a bottom plate and a plurality of sidewalls. The sidewalls protrude from sides of the bottom plate. Each of the sidewalls includes a first combining protrusion and a first combining recess. The first combining protrusion and the first combining recess extend in a direction substantially parallel with the protruded direction of the sidewall. The mold frame is disposed in the rear receiving container to press a peripheral portion of the optical film assembly. The mold frame includes a second combining recess and a second combining protrusion. The second combining recess and the second combining protrusion extend in the direction substantially parallel with the protruded direction. The second combining recess is fitted with the first combining protrusion. The second combining protrusion is fitted with the first combining recess. The display panel is disposed on the mold frame of the backlight assembly and is configured to control transmittance of the light to display an image.

In an embodiment, the display apparatus may further include a front receiving container combined with the backlight assembly to receive the display panel.

In an embodiment, the front receiving container may press the display panel toward the backlight assembly and the display panel may press the mold frame toward the rear receiving container to restrict movement of the mold frame and the rear receiving container.

In an embodiment, the front receiving container may include a fixing protrusion, and the rear receiving container may include a stopping recess into which the fixing protrusion is hooked.

In an embodiment, a rear receiving groove may be further formed on a rear surface of the mold frame, and the sidewalls of the rear receiving container may be in the rear receiving groove.

In an embodiment, the mold frame may further include a fixing hole through which the fixing protrusion passes.

In an embodiment, the first and second combining protrusions may have a wedge shape.

According to an exemplary embodiment, a method of fabricating a display apparatus is provided as follows. A light source member and an optical film assembly are disposed on a bottom plate of a rear receiving container. The rear receiving container includes the bottom plate and a plurality of sidewalls protruding from sides of the bottom plate. Each of the sidewall includes a first combining protrusion and a first combining recess. The first combining protrusion and the first combining recess extend in a direction substantially parallel with the protruded direction of the sidewall. A mold frame including a second combining recess and a second combining protrusion is pressed to fit the first combining protrusion and the first combining recess to the second combining recess and the second combining protrusion, respectively. The second combining recess and the second combining protrusion extend in a direction substantially parallel with the protruded direction. A display panel is disposed on the mold frame. A front receiving container is pressed from an upper surface of the display panel toward the rear receiving container along the protruded direction. The front receiving container is combined with the rear receiving container to restrict the display panel and the mold frame in the protruded direction.

In an embodiment, the front receiving container may be combined with the rear receiving container by hooking a fixing protrusion of the front receiving container to a stopping recess of the rear receiving container.

In an embodiment, the mold frame may be pressed toward the rear receiving container by inserting the sidewalls of the rear receiving container into a rear receiving groove formed on a rear surface of the mold frame.

According to the present inventive concept, the mold frame is horizontally fixed to the rear receiving container, and is vertically fixed to the front receiving container. That is, the fixation of the mold frame in different directions is shared by the rear receiving container in the horizontal direction and the front receiving container in the vertical direction. Thus, the elements of the display apparatus are securely combined and the fabrication process becomes simple. Also, the combining protrusion and the combining grooves may have a wedge shape to prevent the dislocation of the mold frame from inside of the rear receiving container. The combining protrusion and the combining grooves may also have a rounded hammer shape, a rectangular hammer shape, etc.

Also, when the second combining protrusion, the second combining groove, the first combining protrusion and the first combining groove have lower height than the mold frame, the second combining protrusion of the mold frame and the second combining groove may be hooked by the first combining protrusion and the first combining groove of the rear receiving container during the fabrication process.

In addition, the sidewalls of the rear receiving container is inserted in to the rear receiving groove of the mold frame, and the fixing protrusion of the receiving container passes through the fixing hole of the mold frame to be hooked by the stopping groove of the rear receiving container. Therefore, the upper receiving container, the mold frame and the rear receiving container are securely combined.

### BRIEF DESCRIPTION OF THE DRAWINGS

The above and other features and advantages will become more apparent by describing exemplary embodiments thereof with reference to the accompanying drawings, in which:

FIG. 1 is an exploded perspective view illustrating a display apparatus according to an exemplary embodiment of the present inventive concept.

FIG. 2 is a cross-sectional view taken along a line I-I′ of FIG 1.

FIG. 3 is a plan view illustrating the backlight assembly of FIG 1.

FIG. 4 is a plan view illustrating a combining structure between a rear receiving container and a mold frame according to an exemplary embodiment of the present inventive concept.

FIG. 5A is a plan view illustrating a first combining protrusion of FIG. 4.

FIG. 5B is a plan view illustrating a second combining protrusion of FIG. 4.

FIG. 6 is a plan view illustrating a combining structure between a rear receiving container and a mold frame according to an exemplary embodiment of the present inventive concept.

FIG. 7A is a plan view illustrating a first combining protrusion of FIG. 6.

FIG. 7B is a plan view illustrating a second Combining protrusion of FIG. 6.

FIG. 8 is an exploded perspective view illustrating a display apparatus according to an exemplary embodiment of the present inventive concept.

FIG. 9 is a cross-sectional view taken along II-II′ line of FIG. 8.

FIG. 10 is an exploded perspective view illustrating a display apparatus according to an exemplary embodiment of the present inventive concept.

FIG. 11 is a cross-sectional view taken along III-III′ line of FIG. 10.

FIG. 12 is a rear view illustrating a mold frame of FIG 10.

### DETAILED DESCRIPTION

Hereinafter, exemplary embodiment of the inventive concept will be explained in detail with reference to the accompanying drawings.

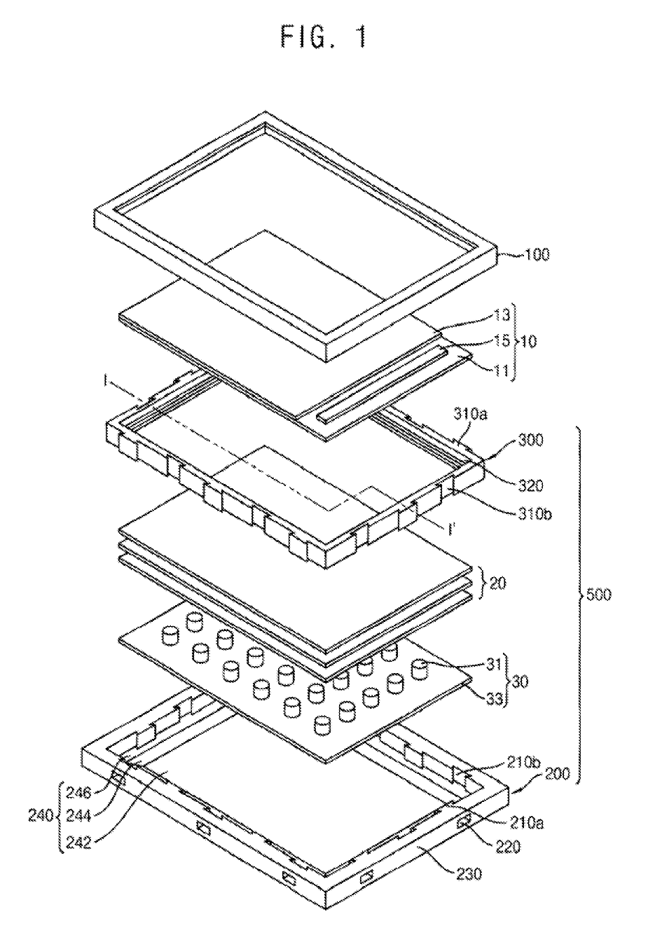

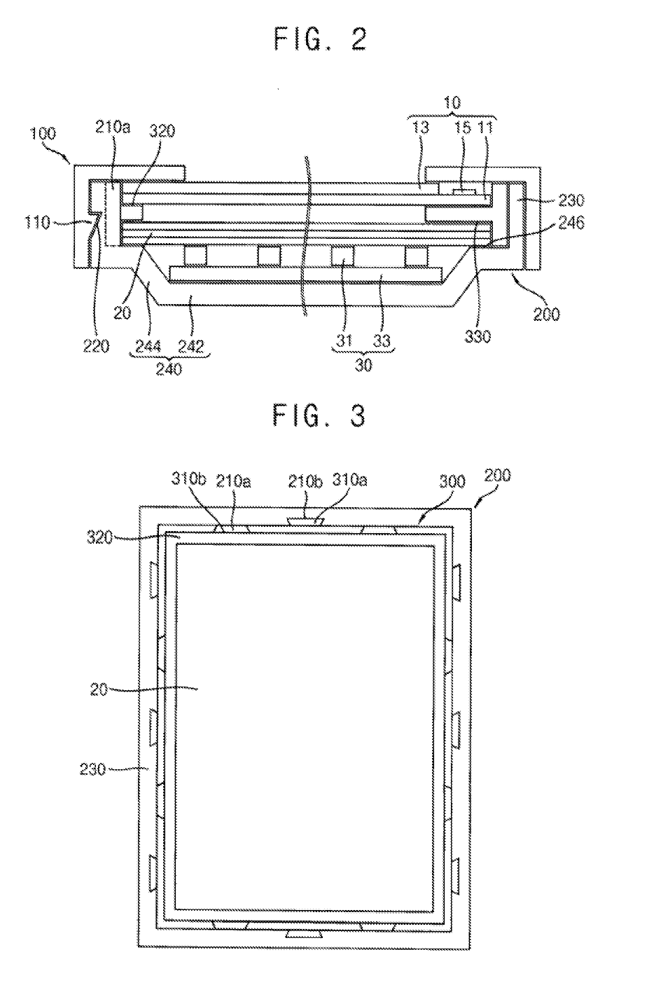

FIG. 1 is an exploded perspective view illustrating a display apparatus according to an exemplary embodiment of the present inventive concept. FIG. 2 is a cross-sectional view taken along a line I-I′ of FIG. 1.

Referring to FIGS. 1 and 2, the display apparatus includes a backlight assembly 500 and a display panel 10. In the present example embodiment, the display apparatus may further include a front receiving container 100. The front receiving container 100 is combined with the backlight assembly 500 to receive the display panel 10.

The display panel 10 includes a lower substrate 11, an upper substrate 13 and a driving circuit 15. In the present example embodiment, the display panel 10 may further include a light controlling layer (not shown) interposed between the upper substrate 13 and the lower substrate 11 to control light transmittance of the light having passed through the light controlling layer (not shown).

The display panel 10 displays an image using light supplied from the backlight assembly 500. For example, the display panel 10 may include a liquid crystal element, an electrophoretic element, etc. When the display panel 10 includes the liquid crystal element, a liquid crystal layer (not shown) is interposed between the upper substrate 13 and the lower substrate 11 and the upper substrate 13 and the lower substrate 11 apply an electric field to the liquid crystal layer (not shown) to control the light transmittance of the light having passed through the liquid crystal layer (not shown).

For example, a phase delay film (not shown), a window (not shown), a polarizing film (not shown), etc., may be disposed on the display panel 10.

The backlight assembly 500 is disposed under the display panel 10 to supply the light to the display panel 10 and to support the display panel 10.

In the present example embodiment the backlight assembly 500 includes a rear receiving container 200, a light source member 30, an optical film assembly 20 and a mold frame 300.

The rear receiving container 200 includes a bottom plate 240 and a plurality of sidewalls 230 surrounding the bottom plate 240.

The bottom plate 240 includes a bottom surface 242, a supporting surface 246 and an inclined surface 244.

The bottom surface 242 is disposed on a central portion of the bottom plate 240 and is the lowest surface. The light source member 30 is disposed on the bottom surface 242 to be supported by the bottom surface 242.

The supporting surface 246 surrounds the bottom surface 242 and is higher than the bottom surface 242. The optical film assembly 20 is disposed on the supporting surface 246 to be supported by the supporting surface 246.

The inclined surface 244 is interposed between the bottom surface 242 and the supporting surface 246 to connect the bottom surface 242 to the supporting surface 246.

The sidewalls 230 are protruded from sides of the bottom plate 240. In the present example embodiment, the sidewalls 230 have a substantially rectangular shape.

The sidewalls 230 include a first combining protrusion 210a and a first combining groove 210b, sometimes called a first combining recess 210b. The first combining protrusion 210a and the first combining groove 210b are extended in a direction substantially perpendicular to a protruded direction of the sidewalls 230. In the present example embodiment, the first combining protrusion 210a and the first combining groove 210b are formed on an inside of the sidewalls 230, and have a substantially wedge shape. For example, the first combining protrusion 210a is protruded from the inside of the sidewall 230 toward an inside of the rear receiving container 200. The first combining groove 210b is recessed from the inside of the sidewall 230 toward an outside of the rear receiving container 200.

A stopping recess 220, sometime called a stopping groove 220, is formed on the sidewall 230. In the present example embodiment, the stopping groove 220 is formed on an outer surface of the sidewall 230, which is opposite to the inner surface on which the first combining protrusion 210a or the first combining recess 210b is formed. In another example embodiment, the stopping groove 220, the first combining protrusion 210a and the first combining recess 210b may be formed on the same inner or outer surface.

In the present example embodiment, the first combining protrusion 210a and the first combining recess 210b may have a substantially same height as the mold frame 300, and the sidewalls 230 of the rear receiving container 200 may be higher than the mold frame 300. Thus, the first combining protrusion 210a and the first combining recess 210b are disposed in the sidewalls 230, and a lower portion of the first combining protrusion 210a and the first combining recess 210b are disposed at a higher position than a lower side of the sidewalls 230. In another example embodiment, the first combining protrusion 210a and the first combining recess 210b may have lower height than the mold frame 300.

The rear receiving container 200 receives the light source member 30, the optical film assembly 20 and the mold frame 300. In the present example embodiment, the rear receiving container 200 includes rigid material such as metal, synthetic resin, etc., to protect the light source member 30, the optical film assembly 20 and the mold frame 300 from an externally provided impact.

The light source member 30 is disposed on the bottom surface 242 of the rear receiving container 200 to generate the light. The light source member 30 includes a light source 31 and a light source substrate 33.

The light source 31 includes a light emitting diode (LED), a cold cathode fluorescent lamp (CCFL), etc. In the present example embodiment, the light source 31 includes a plurality of light emitting diodes (LED). For example, the light emitting diodes may be individually operated based on an image signal from the display panel 10.

The light source 31 is disposed on the light source substrate 33. For example, the light source 31 may be arranged in a matrix shape on the light source substrate 33.

For example, a reflecting member (not shown) may be disposed between the light source member 30 and the rear receiving container 200. The reflecting member (not shown) guides the light generated from the light source member 30 toward the display panel 10, thereby improving luminance of the display apparatus.

The optical film assembly 20 is disposed on the supporting surface 246 of the rear receiving container 200 to improve luminance uniformly of the light generated from the light source member 30. For example, the optical film assembly 20 includes a prism sheet, a diffusion film, etc.

The mold frame 300 is disposed in the rear receiving container 200 to press a peripheral portion of the optical film assembly 20, thereby fixing the optical film assembly 20. In the present example embodiment, the mold frame 300 has a substantially rectangular frame shape having a central void.

In the present example embodiment, a protrusion having a substantially rectangular ring shape is formed in an inside of the mold frame 300, thereby forming a panel supporting portion 320 and an optical member receiving portion 330.

The panel 10 is supported by the panel supporting portion 320. The optical member receiving portion 330 presses and fixes a peripheral portion of the optical film assembly 20.

The mold frame 300 is combined with a second combining protrusion 310a and a second combining recess 310b. The second combining protrusion 310a and the second combining recess 310b are extended in a direction substantially parallel with a vertical direction of the mold frame 300. In the present example embodiment, the second combining protrusion 310a and the second combining recess 310b are formed on an outer surface of the mold frame 300, and have a substantially wedge shape. For example, the second combining protrusion 310a is protruded from an outer surface of the mold frame 300 toward an outside of the mold frame 300. The second combining recess 310b is recessed from the outside of the mold frame 300 toward the inside of the mold frame 300.

In the present example embodiment, the second combining protrusion 310a and the second combining recess 310b have substantially the same height as the mold frame 300. In another example embodiment, the second combining protrusion 310a and the second combining recess 310b have a smaller height than the mold frame 300.

In the present example embodiment, the mold frame 300 has a rigid material having strength such as metal, synthetic resin, etc., to rigidly fix the light source member 30, sometimes called an optical member 30, and the optical film assembly 20 to securely support the display panel 10.

FIG. 3 is a plan view illustrating the backlight assembly of FIG. 1.

Referring to FIGS. 1 to 3, the second combining protrusion 310a of the mold frame 300 is combined with the first combining recess 210b of the rear receiving container 200. The second combining recess 310b of the mold frame 300 is combined with the first combining protrusion 210a of the rear receiving container 200.

A plurality of the second combining protrusions 310a and the second combining recesses 310b are formed along the outer surface of the mold frame 300. A plurality of the first combining protrusions 210a and the first combining recesses 210b are formed along the inside of the rear receiving container 200. The second combining protrusion 310a and the first combining protrusion 210a are inserted into the first combining recess 210b and the second combining recess 310b in the vertical direction to be combined with each other, respectively. Thus, the mold frame 300 and the rear receiving container 200 restrict the backlight assembly 500 in the vertical direction.

Referring again to FIGS. 1 and 2, the display panel 10 is disposed on the panel supporting portion 320 of the mold frame.

The front receiving container 100 is combined with the backlight assembly 500 to fix the display panel 10 to the mold frame 300. In the present example embodiment, the front receiving container 100 includes a strong material such as metal, synthetic resin, etc., to protect the display panel 10 and the mold frame 300 from an externally provided impact.

In the present example embodiment, a fixing protrusion 110 is formed on an inner surface of the front receiving container 100. The fixing protrusion 110 is received in the stopping recess 220 formed on the outer surface of the rear receiving container 200 so that the front receiving container 100 is combined with the rear receiving container 200. For example, the fixing protrusion 110 may be hooked with the stopping recess 220.

In the present example embodiment, the front receiving container 100 is combined with the backlight assembly 500 in a vertical direction, and presses the mold frame 300 and a peripheral portion of an upper surface of the display panel 10. Thus, the front receiving container 100 vertically restricts the mold frame 300 and the rear receiving container 200.

A method of fabricating the display apparatus of the present inventive concept, and the vertical combination and the horizontal combination of the display apparatus will be explained as followed.

Referring to FIGS. 1 and 2, the light source member 30 is disposed on the bottom surface 242, sometimes called the lower surface 242, of the rear receiving container 200.

The optical film assembly 20 is disposed on the supporting surface 246 of the rear receiving container 200 on which the light source member 30 is disposed.

The mold frame 300 is combined with the rear receiving container 200 in the vertical direction, on which the light source member 30 and the optical film assembly 20 are disposed. The second combining protrusion 310a and the second combining recess 310b of the mold frame 300 are combined with the first combining recess 210b and the first combining protrusion 210a of the rear receiving container 200 in the vertical direction, respectively. When the mold frame 300 is combined with the rear receiving container 200, the peripheral portion of the optical film assembly 20 makes contact with the optical member receiving portion 330 of the mold frame 300.

The display panel 10 is disposed on the panel supporting portion 320 of the mold frame 300.

The front receiving container 100, sometimes called the upper receiving container 100, is combined with the rear receiving container 200 in the vertical direction. The upper receiving container 100 is pressed until the fixing protrusion 110 is hooked by the stopping recess 220 of the rear receiving container 200. When the upper receiving container 100 is passed toward the rear receiving container 200, the display panel 10, the mold frame 300, the optical film assembly 20 and the optical member 30 that are disposed between the upper receiving container 100 and the rear receiving container 200 are also pressed in the vertical direction.

Thus, the display panel is fabricated.

The second combining protrusion 310a and the second combining recess 310b of the mold frame 300 and the first combining protrusion 210a and the first combining recess 210b of the rear receiving container 200 are extended in the vertical direction of the backlight assembly 500 and have the substantially wedge shape. The second combining protrusion 310a, the second combining recess 310b, the first combining protrusion 210a and the first combining recess 210b are fitted to vertically restrict the mold frame 300 and the rear receiving container 200 in the vertical direction of the backlight assembly 500. When the mold frame 300 and the rear receiving container 200 are vertically restricted, the optical member 30 and the optical film assembly 20 that are disposed between the mold frame 300 and the rear receiving container 200 are horizontally restricted.

Also, the fixing protrusion 110 of the upper receiving container 100 is vertically combined with the stopping recess 220 of the rear receiving container 200 in the vertical direction so that the front receiving container 100, the rear receiving container 200 and the mold frame 300 are vertically restricted. When the front receiving container 100, the rear receiving container 200 and the mold frame 300 are vertically restricted, the display panel 10 interposed between the front receiving container 100 and the mold frame 300 and the optical film assembly 20 and the optical member 30 interposed between the mold frame 300 and the rear receiving container 200 are vertically restricted.

According to the present example embodiment, the mold frame 300 and the rear receiving container 200 are only horizontally restricted, and the backlight assembly 500 is vertically restricted by the upper receiving container 100. Thus, the elements of the display apparatus are securely combined and the fabrication process is simplified.

Also, the combining protrusions 210a and 310a and the combining recesses 210b and 310b have the substantially wedge shape to prevent the dislocation of the mold frame 300 from the inside of the rear receiving container 200.

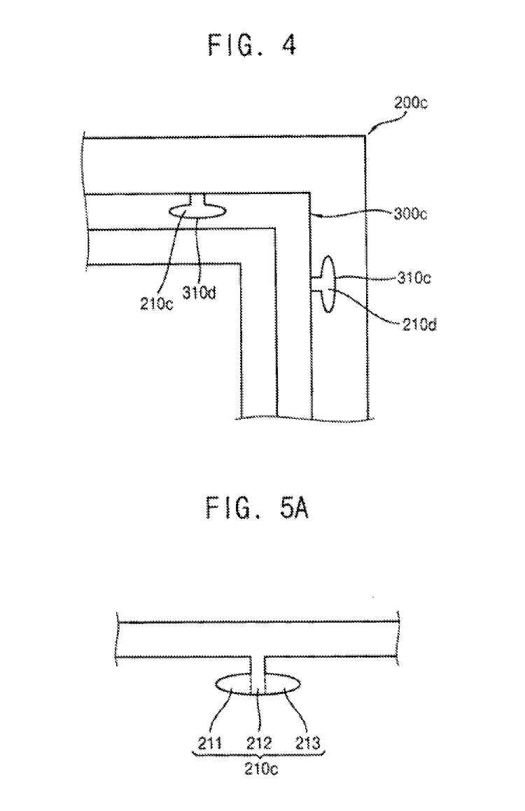

FIG. 4 is a plan view illustrating a combining structure between a rear receiving container and a mold frame according to an exemplary embodiment of the present inventive concept. In the present example embodiment, the display apparatus of FIG. 4 is substantially the same as shown in FIGS. 1 and 3 except the second combining protrusion, the second combining recess, the first combining protrusion and the first combining recess. Thus, any further explanations concerning the same elements will be omitted.

Referring to FIGS. 1 to 4, the display apparatus includes a backlight assembly 500, a display panel 10 and a front receiving container 100.

The backlight assembly 500 includes a rear receiving container 200c, a light source member 30, an optical film assembly 20 and a mold frame 300c.

The rear receiving container 200c includes a bottom plate 240 and a plurality of sidewalls 230 surrounding the bottom plate 240.

The sidewall 230 includes a first combining protrusion 210c and a first combining recess 210d. The first combining protrusion 210c and the first combining recess 210d are extended in a direction substantially perpendicular to a protruded direction of the sidewall 230. For example, the first combining protrusion 210c is protruded from an inside of the sidewall 230 toward an inside of the rear receiving container 200c. The first combining recess 210d is recessed from the inside of the sidewall 230 toward the inside of the rear receiving container 200c.

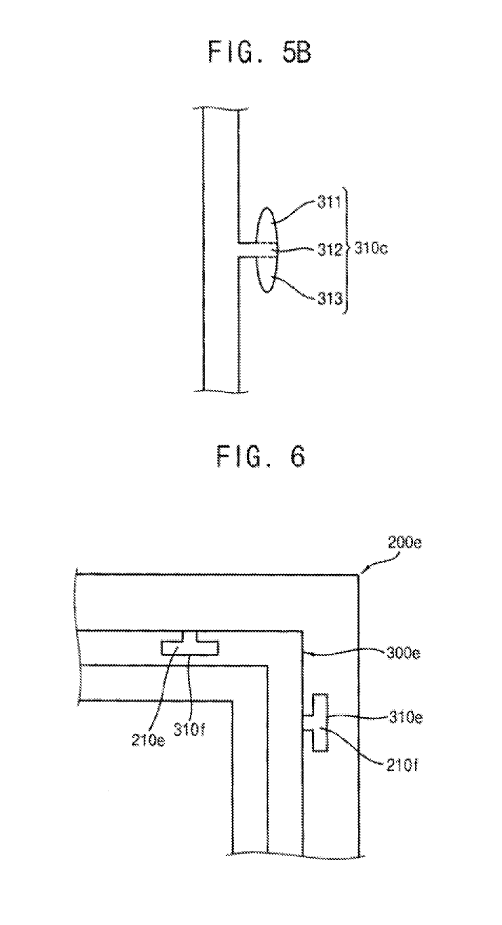

FIG. 5A is a plan view illustrating a first combining protrusion of FIG. 4.

Referring to FIGS. 1 to 5A, the first combining protrusion 210c and the first combining recess 210d are formed on an inside of the sidewall 230, and have a substantially rounded shaped hammer.

In the present example embodiment, the second combining protrusion 210c includes a central portion 212, a first wing portion 211 and a second wing portion 213. The central portion 212 is protruded from the sidewall 230 of the rear receiving container 200c.

The first wing portion 211 and the second wing portion 213 of the first combining protrusion 210c are protruded from an end portion of the central portion 212 of the first combining protrusion 210c in both directions.

The mold frame 300c includes a second combining protrusion 310c and a second combining recess 310d.

FIG 5B is a plan view illustrating the second combining protrusion 310c of FIG. 4.

Referring to FIGS. 1 to 4 and 5B, the second combining protrusion 310c and the second combining recess 310d are extended in a direction substantially parallel with a vertical direction of the mold frame 310c. In the present example embodiment, the second combining protrusion 310c and the first combining recess 310d are formed on an outer surface of the mold frame 300c, and have a substantially rounded hammer shape.

In the present example embodiment, the second combining protrusion 310c includes a central portion 312, a first wing portion 311 and a second wing portion 313. The central portion 312 is protruded from an outer surface of the mold frame 300c.

The first wing portion 311 and the second wing portion 313 of the second combining protrusion 310c are protruded from an end portion of the central portion 312 of the second combining protrusion 310c in both directions.

For example, the second combining protrusion 310c is protruded from an outer surface of the mold frame 300c toward an outside of the display apparatus. The second combining recess 310d is recessed from the outer surface of the mold frame 300c toward an inside of the mold frame 300c.

Referring to FIGS. 4 to 5B, the second combining protrusion 310c of the mold frame 300c is combined with the first combining recess 210d of the rear receiving container 200c, and the second combining recess 310d of the mold frame 300c is combined with the first combining protrusion 210c of the rear receiving container 200c.

The second combining protrusion 310c and the first combining protrusion 210c are inserted into the first combining recess 210d and the second combining recess 310d in a vertical direction to be combined with the first combining recess 210d and the second combining recess 310d. Thus, the mold frame 300c and the rear receiving container 200c are restricted in a vertical direction of the backlight assembly 500 (shown in FIG. 1).

The fabrication method of the display apparatus of the present inventive concept, the combination in the vertical direction and the combination in the horizontal direction are substantially the same as shown in FIGS. 1 to 3.

The second combining protrusion 310c, the second combining recess 310d, the first combining protrusion 210c and the first combining recess 210d are fitted with each other to restrict the mold frame 300c and the rear receiving container 200c to the backlight assembly 500 in the horizontal direction. When the mold frame 300c and the rear receiving container 200c are horizontally restricted, the optical member 30 and the optical film assembly 20 that are interposed between the mold frame 300c and the rear receiving container 200c are also restricted in the horizontal direction.

Also, the fixing protrusion 110 of the upper receiving container 100 is combined with the stopping recess 230 of the rear receiving container 200c so that the front receiving container 100, the rear receiving container 200c and the mold frame 300c are restricted in the vertical direction. When the front receiving container 100, the rear receiving container 200c and the mold frame 300c are vertically restricted, the display panel 10 interposed between the front receiving container 100 and the mold frame 300c, the optical film assembly 20 interposed between the mold frame 300c and the rear receiving container 200c and the optical member 30 are restricted in the vertical direction.

According to the present example embodiment, the combining protrusions 210c and 310c and the combining recesses 210d and 310d have the wing portions 211, 213, 311 and 313 so that the mold frame 300c is securely combined with the rear receiving container 200c.

FIG. 6 is a plan view illustrating a combining structure between a rear receiving container and a mold frame according to an exemplary embodiment of the present inventive concept. In the present example embodiment, the display apparatus of FIG. 6 is substantially the same as shown in FIGS. 1 to 3 except the second combining protrusion, the second combining recess, the first combining protrusion and the first combining recess. Thus, any repetitive explanation concerning the same elements will be omitted.

Referring to FIGS. 1 to 3, and 6, the display apparatus includes a backlight assembly 500, a display panel 10 and a front receiving container 100.

The backlight assembly 500 includes a rear receiving container 200e, a light source member 30, an optical film assembly 20 and a mold frame 300e.

The rear receiving container 200e includes a bottom plate 240 and a plurality of sidewalls 230 surrounding the bottom plate 240.

The sidewalls 230 include a first combining protrusion 210e and a first combining recess 210f. The first combining protrusion 210e and the first combining recess 210f are extended in a direction substantially perpendicular to a protruded direction of the sidewall 230. For example, the first combining protrusion 210e is protruded from an inside of the sidewall 230 toward as inside of the rear receiving container 200. The first combining recess 210f is recessed from the inside of the sidewall 230 toward an outside of the rear receiving container 200e.

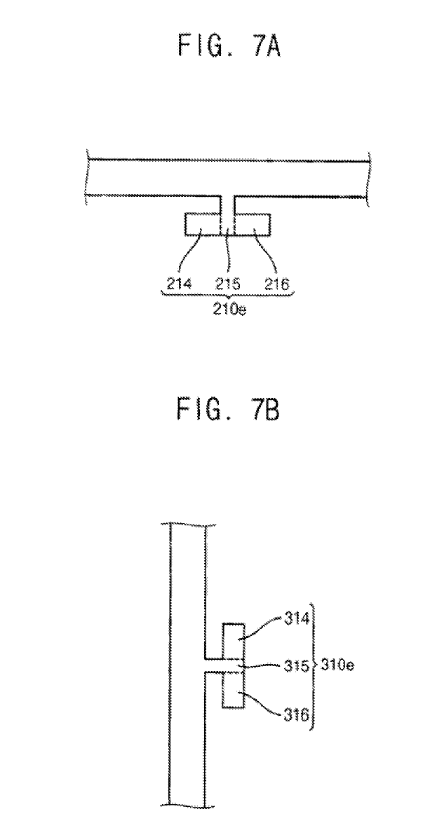

FIG 7A is a plan view illustrating the first combining protrusion 210e of FIG 6.

Referring to FIGS. 1 to 3, 6 and 7A, the first combining protrusion 210e and the first combining recess 210f are disposed at an inner surface of the sidewall 230, and have a substantially square shaped hammer.

In the present example embodiment, the second combining protrusion 210e includes a central portion 215, a first wing portion 214 and a second wing portion 216. The central portion 215 is protruded from an inside of the sidewall 230 of the rear receiving container 200e.

The first wing portion 214 and the second wing portion 216 of the first combining protrusion 210e are protruded from an end portion of the central portion 215 of the first combining protrusion 210e in both directions.

The mold frame 300e includes the second combining protrusion 310e and the second combining recess 310f.

FIG. 7B is a plan view illustrating a second combining protrusion of FIG. 6.

Referring to FIGS. 1 to 3, 6 and 7B, the second combining protrusion 310e and the second combining recess 310f are extended in a direction substantially parallel with a vertical direction of the mold frame 300e. In the present example embodiment, the second combining protrusion 310e and the first combining recess 310f are formed on an outer surface of the mold frame 300e, and have a substantially square hammer shape.

In the present example embodiment, the second combining protrusion 310e includes a central portion 315, a first wing portion 314 and a second wing portion 316. The central portion 315 is protruded from an outer surface of the mold frame 300e.

The first wing portion 314 and the second wing portion 316 of the second combining protrusion 310e are protruded from an end portion of the central portion 315 of the second combining protrusion 310e in both directions.

For example, the second combining protrusion 310e is protruded from an outer surface of the mold frame 300e toward an outside of the display apparatus, and the second combining recess 310f is recessed from the outer surface of the mold frame 300e toward an inside of the mold frame 300e.

Referring again to FIGS. 6 to 7B, the second combining protrusion 310e of the mold frame 300e is combined with the first combining recess 210f of the rear receiving container 200e. The second combining recess 310f of the mold frame 300e is combined with the first combined protrusion 210e of the rear receiving container 200e.

The second combining protrusion 310e and the first combining protrusion on 210e are inserted into the first combining recess 210f and the second combining recess 310f in the vertical direction to be combined with the first combining recess 210f and the second combining recess 310f. Thus, the mold frame 300e and the rear receiving container 200e are restricted in the horizontal direction of the backlight assembly 500 (shown in FIG. 1).

The fabrication method of the display apparatus of the present example embodiment, the combination in the vertical direction and the combination in the horizontal direction are substantially the same as shown in FIGS. 1 to 3. Thus, any repetitive explanation concerning the same will be omitted.

The second combining protrusion 310e, the second combining recess 310f, the first combining protrusion 210e and the first combining recess 210f are fitted to horizontally restrict the mold frame 300e and the rear receiving container 200e to the backlight assembly 500 in the horizontal direction. When the mold frame 300e and the rear receiving container 200e are horizontally restricted, the light source member 30 and the optical film assembly 20 interposed between the mold frame 300e and the rear receiving container 200e are horizontally restricted.

Also, the fixing protrusion 110 of the upper receiving container 100 is vertically combined with a stopping recess 220 of the rear receiving container 200e in the vertical direction so that the front receiving container 100, the rear receiving container 200e and the mold frame 300e are vertically restricted. When the front receiving container 100, the rear receiving container 200e and the mold frame 300e are vertically restricted, the display panel 10 interposed between the front receiving container 100 and the mold frame 300e, the optical film assembly 20 interposed between the mold frame 300e and the rear receiving container 200e and the light source member 30 are vertically restricted.

According to the present example embodiment, the combining protrusions 210e and 310e and the combining recesses 210f and 310f have the wing portions 214, 216, 314 and 316 having the substantially rectangular shape so that the mold frame 300e is securely combined with the rear receiving container 200e.

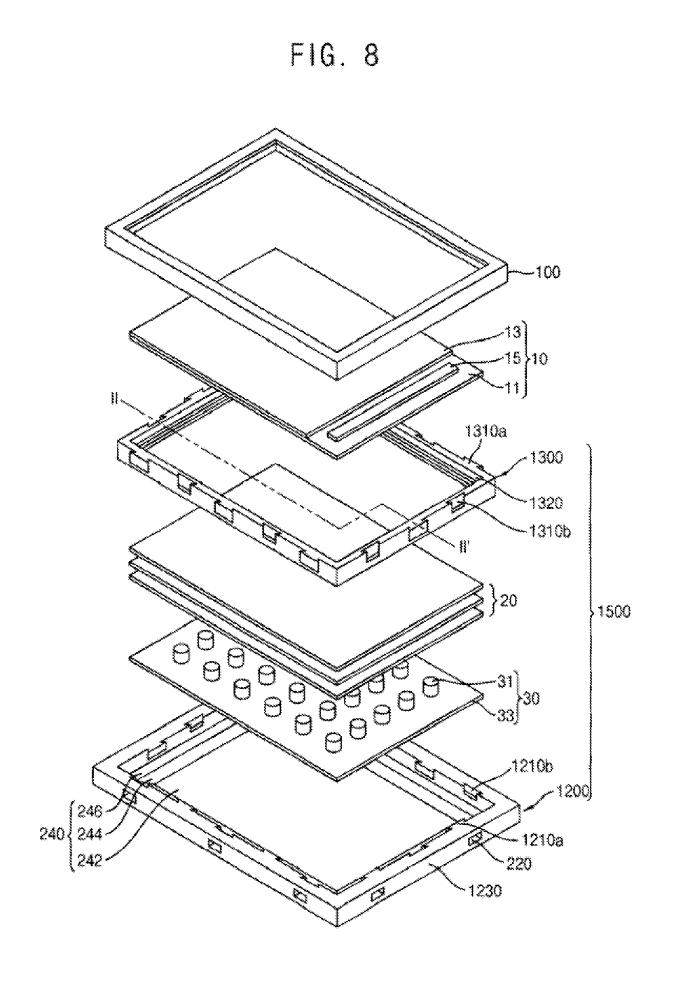

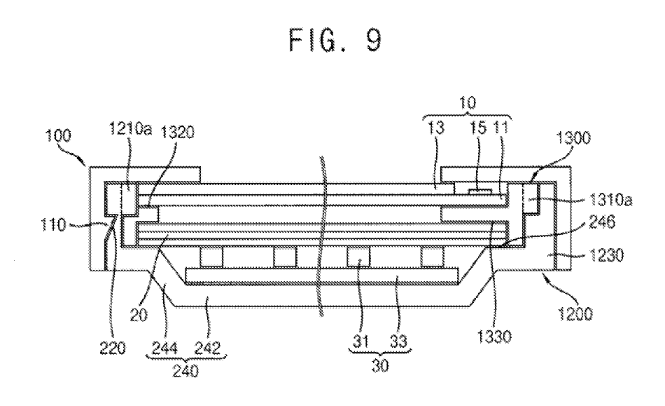

FIGS. 8 is an exploded perspective view illustrating a display apparatus according to an exemplary embodiment of the present inventive concept. FIG 9 is a cross-sectional view taken along II-II′ line of FIG 8. In the present example embodiment, the display apparatus of FIGS. 8 and 9 is substantially the same as shown in FIGS. 1 to 3 except the second combining protrusion, the second combining recess, the first combining protrusion and the first combining recess. Thus, any repetitive explanation concerning the same elements will be omitted.

Referring to FIGS. 8 and 9, the display apparatus includes a backlight assembly 1500 and a display panel 10. In the present example embodiment, the display apparatus may further include a front receiving container 100 that is combined with the backlight assembly 1500 to receive the display panel 10.

The backlight assembly 1500 is disposed under the display panel 10 to supply light to the display panel 10, thereby supporting the display panel 10.

The backlight assembly 1500 includes a rear receiving container 1200, a light source member 30, an optical film assembly 20 and a mold frame 1300.

The rear receiving container 1200 includes a bottom plate 240 and a plurality of sidewalls 1230 surrounding the bottom plate 240.

The bottom plate 240 includes a bottom surface 242, a supporting surface 246 and an inclined surface 244.

The bottom surface 242 is disposed on a central portion and is the lowest surface. The supporting surface 246 surrounds the bottom surface 242 and is higher than the bottom surface 242. The optical film assembly 20 is disposed on the supporting surface 246 to be supported by the supporting surface 246. The inclined surface 244 is interposed between the bottom surface 242 and the supporting surface 246 to connect the bottom surface 242 and the supporting surface 246.

The sidewalls 1230 are protruded from sides of the bottom plate 240, and have a substantially rectangular shape.

The sidewalls 1230 have a first combining protrusion 1210a and a first combining recess 1210b. The first combining protrusion 1210a and the first combining recess 1210b are extended in a protruded direction of the sidewall 1230. In the present example embodiment, the first combining protrusion 1210a and the first combining recess 1210b are formed on an inner surface of the sidewall 1230, and have a substantially wedge shape.

A stopping recess 220 is formed on an outer surface of the sidewall 1230.

In the present example embodiment, the first combining protrusion 1210a and the first combining recess 1210b are formed on an upper portion of the sidewall 1230. The first combining protrusion 1210a and the first combining recess 1210b have a smaller height than the mold frame 1300. The sidewall 1230 of the rear receiving container 1200 is higher than the mold frame 1300. Thus, the first combining protrusion 1210a and the first combining recess 1210b are disposed in the sidewall 1230. A lower portion of the first combining protrusion 1210a and the first combining recess 1210b are disposed at a position higher than the supporting surface 246 of the sidewall 1230.

When, the second combining protrusion 1310a, the second combining recess 1310b, the first combining protrusion 1210a and the first combining recess 1210b have smaller height than the mold frame 1300, the second combining protrusion 1310a and the second combining recess 1310b of the mold frame 1300 are hooked by the first combining recess 1210b and the first combining protrusion 1210a of the rear receiving container 1200 during a fabricating process. Thus, the mold frame 1300 is combined with the rear receiving container 1200 at a precise height.

The mold frame 1300 is disposed in the rear receiving container 1200 to press a peripheral portion of the optical film assembly 20.

The mold frame 1300 has a substantially rectangular frame shape having an empty center. In the present example embodiment, a protrusion having a substantially rectangular ring shape is formed in the mold frame 1300 to form a panel supporting portion 1320 and an optical member receiving portion 1330.

The mold frame 1300 includes the second combining protrusions 1310a and the second combining recess 1310b. The second combining protrusion 1310a and the second combining recess 1310b are extended in a direction substantially perpendicular to the mold frame 1300. In the present example embodiment, the second combining protrusion 1310a and the second combining recess 1310b are formed on an outside of the mold frame 1300, and have a substantially wedge shape. For example, the second combining protrusion 1310a is protruded from an outer surface of the mold frame 1300 toward an outside of the mold frame 1300, and the second combining recess 1310b is recessed from the outer surface of the mold frame 1300 toward an inside of the mold frame 1300.

In the present example embodiment, the second combining protrusion 1310a and the second combining recess 1310b are formed on an upper portion of the panel supporting portion 1320. The second combining protrusion 1310a and the second combining recess 1310b have a smaller height than the mold frame 1300, and have a substantially the same height as the first combining protrusion 1210a and the first combining recess 1210b.

A fabrication method of the display apparatus of the present inventive concept, a horizontal combination and a vertical combination will be explained as follows. The fabrication method of FIGS. 8 and 9 are substantially the same as shown in FIGS. 1 to 3 except combining the mold frame 1300 to the rear receiving container 1200. Thus, any further repetitive explanations concerning the same elements will be omitted.

Referring to FIGS. 8 and 9, the light source member 30 and the optical film assembly 20 are disposed on the bottom surface 242 and the supporting surface 246 of the rear receiving container 1200.

The mold frame 1300 is vertically combined with the rear receiving container 1200, on which the light source member 30 and the optical film assembly 20 are disposed.

In the present example embodiment, the second combining protrusion 1310a and the second combining recess 1310b of the mold frame 1300 are vertically as well as horizontally combined with the first combining recess 1210b and the first combining protrusion 1210a of the rear receiving container 1200. For example, the mold frame 1300 may include an elastic material such as synthetic resin, synthetic rubber, silicon resin, etc., so that a portion of the mold frame 1300 may be bent to decrease a size when viewed on a plane. The bent mold frame 1300 is disposed in the rear receiving container 1200. The mold frame 1300 is strongly pressed toward the rear receiving container 1200, until the second combining protrusion 1310a and the first combining protrusion 1210a are inserted into the first combining recess 1210b and the second combining recess 1310b. In the present example embodiment, the mold frame 1300 is elastic, so that the mold frame 1300 is not broken by brittleness, during the combination between the mold frame 1300 and the rear receiving container 1200.

In the present example embodiment, the second combining protrusion 1310a and the second combining recess 1310b of the mold frame 1300 are hooked by the first combining recess 1210b and the first combining protrusion 1210a of the rear receiving container 1200, so that the mold frame 1300 is combined with the rear receiving container 1200 at a precise position.

When the mold frame 1300 is combined with the rear receiving container 1200, the peripheral portion of the optical film assembly 20 makes contact with the optical member receiving portion 1330 of the mold frame 1300.

The display panel 10 is disposed on the panel supporting portion 1320 of the mold frame 1300.

The front receiving container 100 is combined with the rear receiving container 1200 in the vertical direction. The front receiving container 100 is pressed in the vertical direction until the fixing protrusion 110 of the front receiving container 100 is hooked by the stopping recess 220 of the rear receiving container 1200. When the front receiving container 100 is pressed toward the rear receiving container 1200, the display panel 10, the mold frame 1300, the optical film assembly 20 and the light source member 30 that are interposed between the front receiving container 100 and the rear receiving container 1200 are pressed in the vertical direction.

Therefore, the display apparatus is completed.

According to the present example embodiment, the second combining protrusion 1310a, the second combining recess 1310b, the first combining protrusion 1210a and the first combining recess 1210b have smaller height than the mold frame 1300, so that the second combining protrusion 1310a and the second combining recess 1310b of the mold frame 1300 are hooked by the first combining recess 1210b and the first combining protrusion 1210a of the rear receiving container 1200 during the fabrication process. Thus, the mold frame 1300 is combined with the rear receiving container 1200 at a precise position.

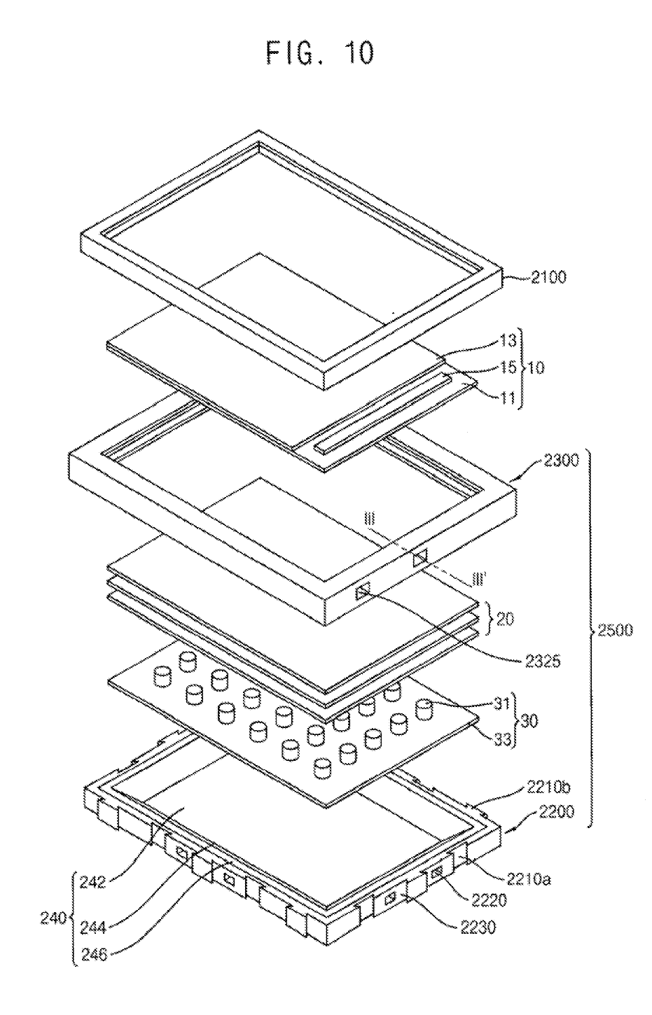

FIG. 10 is an exploded perspective view illustrating a display apparatus according to an exemplary embodiment of the present inventive concept. FIG. 11 is a cross-sectional view taken along III-III′ line of FIG. 10. The display apparatus of FIGS. 10 and 11 are substantially the same as shown in FIGS. 1 to 3 except the rear receiving groove, the second combining protrusion, the second combining recess, the first combining protrusion and the first combining recess. Thus, any further repetitive explanations concerning the above-mentioned elements will be omitted.

Referring to FIGS. 10 and 11, the display apparatus includes a backlight assembly 2500 and a display panel 10. In the present example, the display apparatus may further include a front receiving container 2100 that is combined with the backlight assembly 2500 to receive the display panel 10.

The backlight assembly 2500 is disposed under the display panel 10 to supply light to the display panel 10 and to support the display panel 10.

The backlight assembly 2500 includes a rear receiving container 2200, a light source member 30, an optical film assembly 20 and a mold frame 2300.

The rear receiving container 2200 includes a bottom plate 240 and a plurality of sidewalls 2230 surrounding the bottom plate 240.

The sidewalls 2230 are protruded from sides of the bottom plate 240, and have a substantially rectangular shape.

The sidewalls 2230 include a first combining protrusion 2210a and a first combining recess 2210b. The first combining protrusion 2210a and the first combining recess 2210b are extended in a direction substantially perpendicular to a protruded direction of the sidewall 2230. In the present example, the first combining protrusion 2210a and the first combining recess 2210b are formed on an outer surface of the sidewalls 2230 and have a substantially wedge shape.

A stopping recess 220 is formed on an outer surface of the sidewall 2230.

In the present example embodiment, the first combining protrusion 2210a and the first combining recess 2210b have a substantially same height as the rear receiving container 2200 and the rear receiving groove 2370 of the mold frame 2300. That is, the sidewall 2230 of the rear receiving container 2200 has a smaller height than the mold frame 2300.

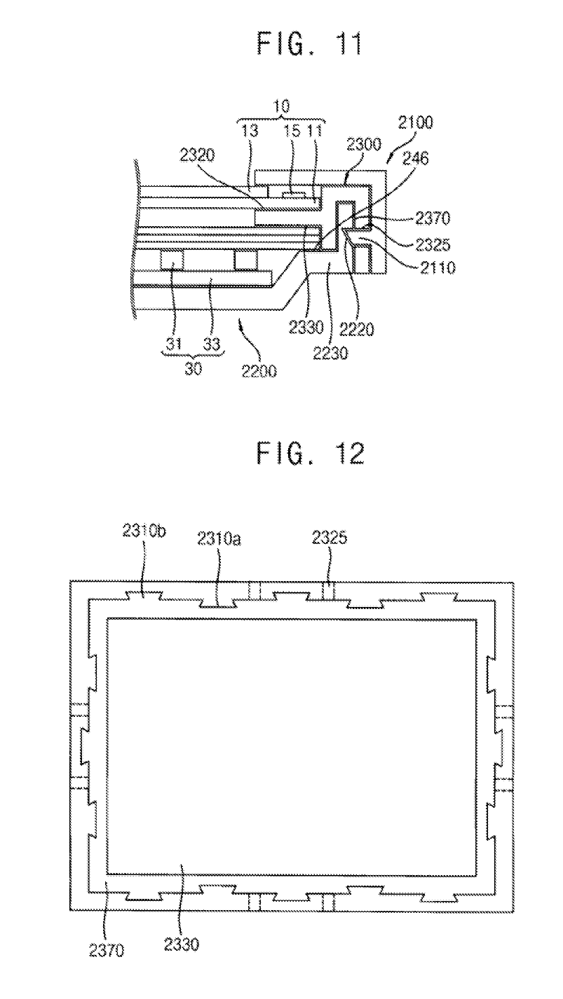

FIG. 12 is a rear view illustrating the mold frame 2300 of FIG. 10.

Referring to FIGS. 10 to 12, the mold frame 2300 is disposed in the rear receiving container 2200, and presses a peripheral portion of the optical film assembly 20 to fix the optical film assembly 20 to the rear receiving container 2200.

The mold frame 2300 has a substantially rectangular frame shape having an empty center. A protrusion having a substantially rectangular ring shape is formed in the mold frame 2300 so that a panel supporting portion 2320 and an optical member receiving portion 2330 are formed in the mold frame 2300.

In the present example embodiment, a rear receiving groove 2370 is formed on a rear surface of the mold frame 2300. The sidewall 2230 of the rear receiving container 2200 is received in the rear receiving groove 2370.

A second combining protrusion 2310a and a second combining recess 2310b are formed on an inner surface disposed in an outside direction of the rear receiving groove 2370 of the mold frame 2300. The second combining protrusion 2310a and the second combining recess 2310b are extended in a direction substantially perpendicular to the mold frame 2300. For example, the second combining protrusion 2310a is protruded from an inside of the rear receiving groove 2370 of the mold frame 2300 toward the inside of the mold frame 2300, and the second combining recess 2310b is recessed from the inside of the rear receiving groove 2370 of the mold frame 2300 toward an outside of the mold frame 2300.

In the present example embodiment, the rear receiving groove 2370 has substantially the same height as the sidewall 2230 of the rear receiving container 2200. The second combining protrusion 2310a and the second combining recess 2310b have substantially the same height as the first combining protrusion 2210a and the first combining recess 2210b.

The fabrication method of the display apparatus of the present inventive concept, the horizontal combination and the vertical combination will be explained as follows. The fabrication method of the present example embodiment is substantially the same as shown in FIGS. 1 to 3 except combining the mold frame 2300 with the rear receiving container 2200 and combining the front receiving container 2100 with the backlight assembly 2500. Thus, any further repetitive explanations concerning the same elements will be omitted.

Referring to FIGS. 10 to 12, the light source member 30 and the optical film assembly 20 are disposed on the lower surface 242 and the supporting surface 246 of the rear receiving container 2200, respectively.

The mold frame 2300 is vertically combined with the rear receiving container 2200 on which the light source member 30 and the optical film assembly 20 are disposed. The sidewall 2230 of a rear receiving container 2200 is received in the rear receiving groove 2370 of the mold frame 2300. The second combining protrusion 2310a and the second combining recess 2310b of the mold frame 2300 are combined with the first combining recess 2210b and the first combining protrusion 2210a of the rear receiving container 2200 in the vertical direction.

When the mold frame 2300 is combined with the rear receiving container 2200, the peripheral portion of the optical film assembly 20 makes contact with the optical member receiving portion 2330, sometimes called the light source receiving portion 2330, of the mold frame 2300.

The display panel 10 is disposed on the panel supporting portion 2320 of the mold frame 2300.

The front receiving container 2100 is combined with the mold frames 2300 in the vertical direction. The front receiving container 2100 is pressed toward the mold frame 2300 in the vertical direction until a fixing protrusion 2110 of the front receiving container 2100 passes through a fixing hole 2325 of the mold frame 2300 to be hooked by a stopping groove 2220 of the rear receiving container 2200. When the front receiving container 2100 is pressed toward the rear receiving container 2200, the display panel 10, the mold frame 2300, the optical film assembly 20 and the light source member 30 that are disposed between the front receiving container 2100 and the rear receiving container 2200 are also pressed in the vertical direction.

Therefore, the display apparatus is completed.

According to the present example embodiment, the sidewalls 2230 of the rear receiving container 2200 are inserted in the rear receiving groove 2370 of the mold frame 2300, and the fixing protrusion 2110 of the front receiving container 2100 passes through the fixing hole 2325 of the mold frame 2300 to be hooked by the stopping groove 2220, sometimes called the stopping recess 2220, of the rear receiving container 2200. Thus, the front receiving container 2100, the mold frame 2300 and the rear receiving container 2200 are securely combined.

According to the example embodiments of the present inventive concept, the mold frame and the rear receiving container are only horizontally restricted, vertical restriction of the display apparatus is performed by the upper receiving container. Thus, the elements of the display apparatus are securely combined and the fabrication process is simplified. Also, the combining protrusion and the combining recesses have the substantially wedge shape to prevent the dislocation of the mold frame from the inside of the rear receiving container. Alternatively, the combining protrusions and the combining recesses may have various shapes such as a substantially rounded hammer shape, a substantially hammer shape, etc.

Also, the second combining protrusion, the second combining recess, the first combining protrusion and the first combining recess have smaller height than the mold frame, so that the second combining protrusion and the second combining recess of the mold frame are hooked by the first combining recess and the first combining protrusion of the rear receiving container during the fabrication process. Thus, the mold frame is combined with the rear receiving container at a precise height.

In addition, the sidewalls of the rear receiving container are inserted in the rear receiving groove of the mold frame, and the fixing protrusion of the front receiving container passes through the fixing hole of the mold frame to be hooked by the stopping recess of the rear receiving container. Thus, the front receiving container, the mold frame and the rear receiving container are securely combined.

Therefore, detects of the display apparatus may be decreased.

The above-mentioned example embodiments disclose direct illumination typed backlight assembly. However, the present inventive concept can also be applied to a side illumination typed backlight assembly.

The foregoing is illustrative of the present teachings and is not to be construed as limiting thereof. Although a few exemplary embodiments have been described, those skilled in the art will readily appreciate from the foregoing that many modifications are possible in the exemplary embodiments without materially departing from the novel teachings and advantages of the present disclosure of inventive concept. Accordingly, all such modifications are intended to be included within the scope of the present teachings. In the claims, means-plus-functions clauses are intended to cover the structures described herein as performing the recited function and not only structural equivalents but also functionally equivalent structures.

What is claimed is:

1. A backlight assembly comprising:
a light source member configured to generate light;
an optical film assembly disposed in the light source member configured to improve optical characteristics of the light;
a rear receiving container that receives the light source member and the optical film assembly, the rear receiving container including:
a bottom plate; and
a plurality of sidewalls protruding from sides of the bottom plate, each of the sidewalls including a first combining protrusion and a first combining recess, the first combining protrusion and the first combining recess extending in a direction substantially parallel with the protruded direction of the sidewall; and
a mold frame disposed in the rear receiving container to press a peripheral portion of the optical film assembly, the mold frame including a second combining recess and a second combining protrusion, the second combining recess and the second combining protrusion extending in the direction substantially parallel with the protruded direction, the second combining recess being fitted with the first combining protrusion, the second combining protrusion being fitted with the first combining recess.

2. The backlight assembly of claim 1, wherein the first and second combining protrusions have a substantially wedge shape.

3. The backlight assembly of claim 1, wherein the first combining protrusion and the second combining protrusion have at least one selected from the group consisting of a rounded hammer shape and a substantially rectangular shape.

4. The backlight assembly of claim 1, wherein the first combining protrusion and the first combining recess are on an inner surface of the sidewall, and the second combining protrusion and the second combining recess are on an outer surface of the mold frame,

5. The backlight assembly of claim 4, wherein the first combining protrusion, the first combining recess, the second combining protrusion and the second combining recess have substantially the same height as the mold frame.

6. The backlight assembly of claim 1, wherein the first combining protrusion, the first combining recess, the second combining protrusion and the second combining recess have a smaller height than the mold frame.

7. The backlight assembly of claim 6, wherein the first combining protrusion and the first combining recess are on an upper portion of the rear receiving container, and the second combining protrusion and the second combining recess are on an upper portion of the mold frame.

8. The backlight assembly of claim 1, wherein a rear receiving groove is on a rear surface of the mold frame, and the sidewall of the rear receiving container is received in the rear receiving groove.

9. The backlight assembly of claim 8, wherein the first combining protrusion and the first combining recess are on an outer surface of the sidewall, the second combining protrusion and the second combining recess are on an inner surface of the rear receiving groove, which faces an outer surface of the sidewall.

10. The backlight assembly of claim 9, wherein the first combining protrusion, the first combining recess, the second combining protrusion and the second combining recess have substantially the same height as the sidewall of the rear receiving container.

11. A display apparatus comprising:
a backlight assembly including:
a light source member configured to generate light;
an optical film assembly disposed on the light source member configured to improve optical characteristics of the light;
a rear receiving container that receives the light source member and the optical film assembly, the rear receiving container including:
a bottom plate; and
a plurality of sidewalls protruding from sides of the bottom plate, each of the sidewalls including a first combining protrusion and a first combining recess, the first combining protrusion and the first combining recess extending in a direction substantially parallel with the protruded direction of the sidewall; and
a mold frame disposed in the rear receiving container to press a peripheral portion of the optical film assembly, the mold frame including a second combining recess and a second combining protrusion, the second combining recess and the second combining protrusion extending in the direction substantially parallel with the protruded direction, the second combining recess being fitted with the first combining protrusion, the second combining protrusion being fitted with the first combining recess; and
a display panel disposed on the mold frame of the backlight assembly configured to control transmittance of the light to display an image.

12. The display apparatus of claim 11, further comprising a front receiving container combined with the backlight assembly to receive the display panel.

13. The display apparatus of claim 12, wherein the front receiving container presses the display panel toward the backlight assembly and the display panel presses the mold frame toward the rear receiving container to restrict movement of the mold frame and the rear receiving container.

14. The display apparatus of claim 12, wherein the front receiving container comprises a fixing protrusion, and the rear receiving container comprises a stopping recess into which the fixing protrusion is hooked.

15. The display apparatus of claim 14, wherein a rear receiving groove is further formed on a rear surface of the mold frame, and the sidewalls of the rear receiving container are in the rear receiving groove.

16. The display apparatus of claim 15, wherein the mold frame further comprises a fixing hole through which the fixing protrusion passes.

17. The display apparatus of claim 11, wherein the first and second combining protrusions have a wedge shape.

18. A method of fabricating a display apparatus, the method comprising:
disposing a light source member and an optical film assembly on a bottom plate of a rear receiving container, the rear receiving container including the bottom plate and a plurality of sidewalls protruding from sides of the bottom plate, each of the sidewall including a first combining protrusion and a first combining recess, the first combining protrusion and the first combining recess extending in a direction substantially parallel with the protruded direction of the sidewall;
pressing a mold frame including a second combining recess and a second combining protrusion to fit the first combining protrusion and the first combining recess to the second combining recess and the second combining protrusion, respectively, the second combining recess and the second combining protrusion, extending in a direction substantially parallel with the protruded direction;
disposing a display panel on the mold frame;
pressing a front receiving container from an upper surface of the display panel toward the rear receiving container along the protruded direction; and
combining the front receiving container with the rear receiving container to restrict the display panel and the mold frame in the protruded direction.

19. The method of claim 18, wherein the front receiving container is combined with the rear receiving container by hooking a fixing protrusion of the front receiving container to a stopping recess of the rear receiving container.

20. The method of claim 18, wherein the mold frame is pressed toward the rear receiving container by inserting the sidewalls of the rear receiving container into a rear receiving groove formed on a rear surface of the mold frame.
